(19) United States
(12) Patent Application Publication
(10) Pub. No.: US 2026/0305646 A1
(43) Pub. Date: Oct. 8, 2026

(54) CONFECTIONERY PRODUCT

(71) Applicants: BUNGE LODERS CROKLAAN B.V., Wormerveer (NL); BUNGE SA, Geneva (CH)

(72) Inventors: Laura OLIVER HERNANDEZ, Wormerveer (NL); Ivana FRANCISCA, Wormerveer (NL); Imro 'T ZAND, Zaandam (NL); Jun MA, Zaandam (NL); Eija Marjatta PIIPSPA, Raisio (FI)

(21) Appl. No.: 19/484,460

(22) PCT Filed: May 16, 2024
(86) PCT No.: PCT/EP2024/063532

§ 371 Date: Nov. 14, 2025

(30) Foreign Application Priority Data
May 17, 2023 (EP) 23173921.0

(51) Int. Cl. A23G 3/40; A23G 1/36; A23G 1/48; A23G 3/48

(52) U.S. Cl. CPC A23G 3/40; A23G 1/36; A23G 1/48; A23G 3/48

(57) ABSTRACT

The invention relates to a confectionery product comprising from 20% to 70% by weight of a sweetener; and from 20% to 70% by weight of a plant-based fat phase; wherein the plant-based fat phase has from 1.0% to 10.0% by weight of total lauric acid (C12:0) and myristic acid (C14:0); and from 20.0% to 70.0% by weight of total palmitic acid (C16:0) and stearic acid (C18:0); said percentages of acid referring to acids bound as acyl groups in glycerides of the plant-based fat phase and being based on the total weight of C8 to C24 fatty acids; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase at least 1.0%; at most 10.0% by weight of total CN32 triglycerides, CN34 triglycerides, CN36 triglycerides, CN38 triglycerides and CN40 triglycerides; based on total triglycerides present in the plant-based fat phase. The invention also relates to a process for preparing the confectionery product.

This invention relates to a confectionery product and a process of preparing the confectionery product.

### BACKGROUND

Fats and oils are important ingredients of food products and used extensively in the food industry. Confectionery products such as chocolate, chocolate-like, coating, filling or spread contain fats and oils which play an important role of textural and organoleptic properties such as mouthfeel, texture, flavour release, flavour intensity, processability and shelf life.

The fat phase of these confectionery products generally contain milk, fat also referred to as butter fat. Not only does milk fat potentially have negative impact on health issues since it contains about 3% trans fatty acid and significant amount of saturated fatty acid, but also it might possibly have negative impact on climate change and sustainability due to emission of carbon dioxide during the production of milk fat.

However, it has been challenging to omit milk fat or any other animal origin fat in the fat phase of confectionery products to obtain a completely plant-based fat phase while still maintaining the similar sensory and textural properties.

WO 2022/248490 relates to fat composition suitable for water-in-oil emulsion product such as margarine or spread. However, there is no disclosure of a confectionery product with a plant-based fat phase.

There remains a need for a confectionery product having a plant-based fat phase without any milk fat or animal origin fat while maintaining desirable textural and organoleptic properties such as mouthfeel and flavour, compared to a conventional confectionery product. There is a further need for a confectionery product having a plant-based fat phase without a high amount of flavour additives but yet having excellent sensory properties compared to a confectionery product with milk fat in the fat phase. There is also a need for a confectionery product having a plant-based fat phase including extra plant-milk powder in order to further reduce the use of milk powder and to increase the presence of plant origin protein and/or fibre in the confectionery products without any negative influence on the organoleptic or textural properties in the presence of plant-milk powder.

### DESCRIPTION OF THE INVENTION

According to the present invention, there is provided a confectionery product comprising from 20% to 70% by weight of a sweetener; and from 20% to 70% by weight of a plant-based fat phase; wherein the plant-based fat phase has from 1.0% to 10.0% by weight of total lauric acid (C12:0) and myristic acid (C14:0); and from 20.0% to 70.0% by weight of total palmitic acid (C16:0) and stearic acid (C18:0); said percentages of acid referring to acids bound as acyl groups in glycerides of the plant-based fat phase and being based on the total weight of C8 to C24 fatty acids; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of at least 1.0%; at most 10.0% by weight of total CN32 triglycerides, CN34 triglycerides, CN36 triglycerides, CN38 triglycerides and CN40 triglycerides; based on total triglycerides present in the plant-based fat phase.

It is believed that the plant-based fat phase of the confectionery product according to the invention with the specified triglyceride and fatty acid composition of both total fat phase and the fatty acids located on the second position of the triglycerides in the fat phase plays an important role in the confectionery product according to the invention having similar desirable sensory properties as conventional milk fat-based confectionery products. It is also believed that the plant-based fat phase of the confectionery product according to the invention is suitable to be used in combination with a plant-milk powder in order to obtain desirable organoleptic properties.

As used herein, articles such as “a” and “an” when used in a claim, are understood to mean one or more of what is claimed or described.

The term “fat” refers to glyceride fats and oils containing fatty acid acyl groups and does not imply any particular melting point. The term “oil” is used herein synonymously with “fat”.

The term “fatty acid” refers to straight chain saturated or unsaturated (including mono- and poly unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1. The fatty acid profile may be determined by fatty acid methyl ester analysis (FAME) using gas chromatography according to ISO 12966-2 and ISO 12966-4. Thus, percentages of fatty acids in compositions (e.g. palmitic acid (C16:0), stearic acid (C18:0), oleic acid (C18:1) etc.) referred to herein, unless otherwise stated, include both acyl groups such as tri-, di- and mono-glycerides and are based on the total weight of C8 to C24 fatty acid residues.

Triglyceride composition may be determined for example based on molecular weight differences (Carbon Number (CN)) by GC (AOCS Ce 5-86). The notation triglyceride CNxx denotes triglycerides having xx carbon atoms in the fatty acyl groups (thus excluding the carbon atoms from the glycerol, as is standard practice) e.g., CN54 includes tristearin. Amounts of triglycerides specified with each carbon number (CN), as is customary terminology in the art, are percentages by weight based on total triglycerides of CN26 to CN62 present in the fat composition.

SN-2 of total palmitic acid and stearic acid % refers to the percentage of total palmitic acid (C16:0) and stearic acid (C18:0) present at the 2-position of the triglyceride in comparison to the percentage of total palmitic acid (C16:0) and stearic acid (C18:0) in the fat sample. The distribution of fatty acids in triglyceride is determined based on joint JOCS/AOCS official method Ch 3a-19. The percentage of total palmitic acid (C16:0) and stearic acid (C18:0) residues in the 2-position is determined by finding: (a) the total palmitic acid (C16:0) and stearic acid (C18:0) content of the fat sample by GC-FAME (ISO 12966-2:2014 and ISO 12966-4:2015) being based on the total weight of C8 to C24 fatty acids; and (b) the total palmitic acid (C16:0) and stearic acid (C18:0) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of total palmitic acid and stearic acid % is thus ((b)×100)/((a)×3) %.

The term “fat phase” refers to the whole fat part included in the confectionery product as disclosed herein. Some confectionery ingredients such as cocoa mass may contain fat in itself. Therefore, fat phase includes both fat as such present as an ingredient in the confectionery product (such as cocoa butter) and fat contained in an ingredient in the confectionery product (such as fat present in cocoa mass which is cocoa butter).

The plant-based fat phase of the confectionery product according to the invention is not, and is not derived from, one or more or animal fats. The plant-based fat phase of the confectionery product according to the invention may be made from naturally occurring (i.e. in plants or other non-animal sources) or synthetic fats, fractions of naturally occurring or synthetic fats, or mixtures thereof, that satisfy the requirements defined herein.

It is also preferred that the plant-based fat phase of the confectionery product according to the invention is, or is derived from non-hydrogenated fats. The term “non-hydrogenated” means that the fat phase is not prepared from a fat that has been subjected to hydrogenation to convert unsaturated fatty acyl groups to saturated fatty acyl groups.

The term “sweetener” refers to a substance that is added to food to provide a sweet taste and is well-known in the art. Sweeteners include sucrose (also generally referred to as ‘sugar’ and which may be provided in refined or unrefined form), glucose, fructose, maltose, syrups such as corn syrup and high fructose corn syrup, honey, polyols including erythritol, maltitol, mannitol, sorbitol, lactitol, xylitol, isomalt, propylene glycol, glycerol (glycerin), threitol, galactitol and palatinose, sucralose, potassium acesulfame, acesulfame acid and salts thereof, aspartame, alitame, neotame, advantame, cyclamate, saccharin and salts thereof, neohesperidin, steviol glucosides, fruit extract and combinations thereof. Those skilled in the art will be able to adjust the amount of sweetener, or combination of sweeteners, to achieve a desired degree of sweetness. Preferred sweeteners are sucrose, glucose, fructose, syrups such as corn syrup and high fructose corn syrup. More preferably, the sweetener of the confectionery product according to the invention is sucrose (i.e. sugar).

The confectionery product according to the invention preferably comprises from 30% to 65% by weight of a sweetener, more preferably from 35% to 60% by weight, even more preferably from 40% to 55% by weight and most preferably from 40% to 50% by weight.

The confectionery product according to the invention preferably comprises from 20% to 60% by weight of the plant-based fat phase as disclosed herein, more preferably from 20% to 50% by weight, even more preferably from 20% to 45% by weight and most preferably from 20% to 40% by weight.

The confectionery product according to the invention preferably comprises at most 10% by weight of water, more preferably at most 5% by weight of water, even more preferably at most 1% by weight of water and most preferably at most 0.1% by weight of water. It is particularly preferred that the confectionery product according to the invention is free or substantially free or essentially free of water. The term “substantially free” or “essentially free” as used herein, unless otherwise specified, includes less than 0.1% by weight of water.

In a preferred aspect, the confectionery product according to the invention comprises from 30% to 65% by weight of a sweetener; from 20% to 60% by weight of the plant-based fat phase as disclosed herein; and at most 10% by weight of water.

In a more preferred aspect, the confectionery product according to the invention comprises from 35% to 60% by weight of a sweetener; from 20% to 50% by weight of the plant-based fat phase as disclosed herein; and at most 5% by weight of water.

In an even more preferred aspect, the confectionery product according to the invention comprises from 40% to 55% by weight of a sweetener; from 20% to 45% by weight of the plant-based fat phase as disclosed herein; and at most 1% by weight of water.

In a most preferred aspect, the confectionery product according to the invention comprises from 40% to 50% by weight of a sweetener; from 20% to 40% by weight of the plant-based fat phase as disclosed herein; and at most 0.1% by weight of water.

The confectionery product according to the invention preferably further comprises one or more ingredients selected from cocoa powder, cocoa mass, skimmed milk powder, vanillin, emulsifier (such as lecithin), colorant and flavoring.

The confectionery product according to the invention preferably further comprises at most 0.10% by weight of butter flavoring, more preferably at most 0.05% by weight, such as from 0.0001% by weight to 0.04% by weight, even more preferably at most 0.01% by weight, such as from 0.0001% by weight to 0.002% by weight and most preferably at most 0.0005% by weight. In another preferred aspect, the confectionery product according to the invention is free or substantially free or essentially free of butter flavoring. The term “substantially free” or “essentially free” as used herein, unless otherwise specified, includes less than 0.0001% by weight of butter flavoring. The term “butter flavoring” refers to a flavoring used to provide or mimic the taste and/or smell of butter which may contain diacetyl, acetylpropionyl, or acetoin.

The confectionery product according to the invention preferably further comprises a plant-based milk powder, such as almond milk powder, soy milk powder, coconut milk powder, rice milk powder, oat milk powder, hemp milk powder, pea milk powder, peanut milk powder, cashew milk powder, triticale milk powder, wheat milk powder, barley milk powder, spelt milk powder, millet milk powder, derives thereof and mixture thereof. The confectionery product according to the invention more preferably further comprises a plant milk powder which is oat milk powder or rice milk powder. The confectionery product according to the invention even more preferably further comprises a plant milk powder which is oat milk powder.

The term “plant-based milk”, which is also known as plant-based liquids, alternative milk, nut milk or vegan milk, and which is a plant juice that has similar appearance to dairy milk, and is also referred to as a manufactured, non-dairy beverage made from a water-based plant extract for flavoring and aroma. The water-based plant extract might be obtainable from plant material as such. Alternatively, the water-based plant extract might also be obtainable from plant material being treated to solubilize water-insoluble parts of the plant material which will subsequently be part of the water-based plant extract. Such treatment of the plant material could be performed enzymatically. The term “plant-based milk powder” is a manufactured plant-based product produced by evaporating water from plant-based milk to dryness.

The confectionery product according to the invention preferably further comprises from 0.001% to 0.5% by weight of plant-based milk powder, more preferably from 0.001% to 0.050% by weight, even more preferably from 0.005% to 0.030% by weight and most preferably from 0.010% to 0.025% by weight.

In a preferred aspect, the confectionery product according to the invention comprises from 30% to 65% by weight of a sweetener; from 20% to 60% by weight of the plant-based fat phase as disclosed herein; at most 10% by weight of water; at most 0.10% by weight of butter flavoring; and one or more ingredients selected from cocoa powder, cocoa mass, skimmed milk powder, vanillin, emulsifier and colorant.

In a more preferred aspect, the confectionery product according to the invention comprises from 35% to 60% by weight of a sweetener; from 20% to 50% by weight of the plant-based fat phase as disclosed herein; and at most 5% by weight of water; at most 0.05% by weight of butter flavoring; and one or more ingredients selected from cocoa powder, cocoa mass, skimmed milk powder, vanillin, emulsifier and colorant.

In an even more preferred aspect, the confectionery product according to the invention comprises from 40% to 55% by weight of a sweetener; from 20% to 45% by weight of the plant-based fat phase as disclosed herein; at most 1% by weight of water; at most 0.01% by weight of butter flavoring; and one or more ingredients selected from cocoa powder, cocoa mass, skimmed milk powder, vanillin, emulsifier and colorant.

In a most preferred aspect, the confectionery product according to the invention comprises from 40% to 50% by weight of a sweetener; from 20% to 40% by weight of the plant-based fat phase as disclosed herein; at most 0.1% by weight of water; at most 0.0005% by weight of butter flavoring; and one or more ingredients selected from cocoa powder, cocoa mass, skimmed milk powder, vanillin, emulsifier and colorant.

In another preferred aspect, the confectionery product according to the invention comprises from 30% to 65% by weight of a sweetener; from 20% to 60% by weight of the plant-based fat phase as disclosed herein; at most 10% by weight of water; at most 0.10% by weight of butter flavoring; from 0.001% to 0.5% by weight of plant-based milk powder; and one or more ingredients selected from cocoa powder, cocoa mass, skimmed milk powder, vanillin, emulsifier and colorant.

In another more preferred aspect, the confectionery product according to the invention comprises from 35% to 60% by weight of a sweetener; from 20% to 50% by weight of the plant-based fat phase as disclosed herein; and at most 5% by weight of water; at most 0.05% by weight of butter flavoring; from 0.001% to 0.050% by weight of plant-based milk powder; and one or more ingredients selected from cocoa powder, cocoa mass, skimmed milk powder, vanillin, emulsifier and colorant.

In another even more preferred aspect, the confectionery product according to the invention comprises from 40% to 55% by weight of a sweetener; from 20% to 45% by weight of the plant-based fat phase as disclosed herein; at most 1% by weight of water; at most 0.01% by weight of butter flavoring; from 0.005% to 0.030% by weight of plant-based milk powder; and one or more ingredients selected from cocoa powder, cocoa mass, skimmed milk powder, vanillin, emulsifier and colorant.

In another most preferred aspect, the confectionery product according to the invention comprises from 40% to 50% by weight of a sweetener; from 20% to 40% by weight of the plant-based fat phase as disclosed herein; at most 0.1% by weight of water; at most 0.0005% by weight of butter flavoring; from 0.010% to 0.025% by weight of plant-based milk powder; and one or more ingredients selected from cocoa powder, cocoa mass, skimmed milk powder, vanillin, emulsifier and colorant.

The confectionery product according to the invention is preferably a chocolate, a chocolate-like product, a coating, a filling, an icing or a spread, more preferably a chocolate, a chocolate-like product, a coating or an icing and even more preferably a chocolate or a chocolate-like product.

In a preferred aspect, the confectionery product according to the invention comprises from 30% to 65% by weight of a sweetener; from 20% to 60% by weight of the plant-based fat phase as disclosed herein; at most 10% by weight of water; at most 0.10% by weight of butter flavoring; and one or more ingredients selected from cocoa powder, cocoa mass, skimmed milk powder, vanillin, emulsifier and colorant, wherein the confectioner product is a chocolate, a chocolate-like product or a coating.

In a more preferred aspect, the confectionery product according to the invention comprises from 35% to 60% by weight of a sweetener; from 20% to 50% by weight of the plant-based fat phase as disclosed herein; and at most 5% by weight of water; at most 0.05% by weight of butter flavoring; and one or more ingredients selected from cocoa powder, cocoa mass, skimmed milk powder, vanillin, emulsifier and colorant, wherein the confectioner product is a chocolate, a chocolate-like product or a coating.

In an even more preferred aspect, the confectionery product according to the invention comprises from 40% to 55% by weight of a sweetener; from 20% to 45% by weight of the plant-based fat phase as disclosed herein; at most 1% by weight of water; at most 0.01% by weight of butter flavoring; and one or more ingredients selected from cocoa powder, cocoa mass, skimmed milk powder, vanillin, emulsifier and colorant, wherein the confectioner product is a chocolate, a chocolate-like product or a coating.

In a most preferred aspect, the confectionery product according to the invention comprises from 40% to 50% by weight of a sweetener; from 20% to 40% by weight of the plant-based fat phase as disclosed herein; at most 0.1% by weight of water; at most 0.0005% by weight of butter flavoring; and one or more ingredients selected from cocoa powder, cocoa mass, skimmed milk powder, vanillin, emulsifier and colorant, wherein the confectioner product is a chocolate, a chocolate-like product or a coating.

In yet another preferred aspect, the confectionery product according to the invention comprises from 30% to 65% by weight of a sweetener; from 20% to 60% by weight of the plant-based fat phase as disclosed herein; at most 10% by weight of water; at most 0.10% by weight of butter flavoring; from 0.001% to 0.5% by weight of oat milk powder; and one or more ingredients selected from cocoa powder, cocoa mass, skimmed milk powder, vanillin, emulsifier and colorant, wherein the confectioner product is a chocolate, a chocolate-like product or a coating.

In yet another more preferred aspect, the confectionery product according to the invention comprises from 35% to 60% by weight of a sweetener; from 20% to 50% by weight of the plant-based fat phase as disclosed herein; and at most 5% by weight of water; at most 0.05% by weight of butter flavoring; from 0.001% to 0.050% by weight of oat milk powder; and one or more ingredients selected from cocoa powder, cocoa mass, skimmed milk powder, vanillin, emulsifier and colorant, wherein the confectioner product is a chocolate, a chocolate-like product or a coating.

In yet another even more preferred aspect, the confectionery product according to the invention comprises from 40% to 55% by weight of a sweetener; from 20% to 45% by weight of the plant-based fat phase as disclosed herein; at most 1% by weight of water; at most 0.01% by weight of butter flavoring; from 0.005% to 0.030% by weight of oat milk powder; and one or more ingredients selected from cocoa powder, cocoa mass, skimmed milk powder, vanillin, emulsifier and colorant, wherein the confectioner product is a chocolate, a chocolate-like product or a coating.

In yet another most preferred aspect, the confectionery product according to the invention comprises from 40% to 50% by weight of a sweetener; from 20% to 40% by weight of the plant-based fat phase as disclosed herein; at most 0.1% by weight of water; at most 0.0005% by weight of butter flavoring; from 0.010% to 0.025% by weight of oat milk powder; and one or more ingredients selected from cocoa powder, cocoa mass, skimmed milk powder, vanillin, emulsifier and colorant, wherein the confectioner product is a chocolate, a chocolate-like product or a coating.

The confectionery product according to the invention further optionally comprises a filler material, preferably wherein the weight ratio of the filler material and the sugar in the confectionery product according to the invention is from 2:1 to 1:10. The term “filler material” refers to a low-calorie filler material that could be applied instead of the sugar. The filler material is preferably selected from maltodextrin, tapioca, fibre (such as corn fibre) or mixtures thereof.

The plant-based fat phase in the confectionery product according to the invention preferably has from 0.5% to 10% by weight of lauric acid (C12:0), more preferably from 1.0% to 8.0% by weight, even more preferably from 1.0% to 6.5% by weight and most preferably from 1.1% to 5.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has at most 8.0% by weight of myristic acid (C14:0), more preferably from 0.1% to 6.0% by weight, even more preferably from 0.5% to 4.0% by weight and most preferably from 0.5% to 3.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has from 1.5% to 9.0% by weight of total lauric acid (C12:0) and myristic acid (C14:0), more preferably from 1.5% to 8.0% by weight, even more preferably from 2.0% to 7.5% by weight and most preferably from 2.0% to 7.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has from 10.0% to 50.0% by weight of palmitic acid (C16:0), more preferably from 15.0% to 45.0% by weight, even more preferably from 18.0% to 40.0% by weight and most preferably from 20.0% to 35.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has from 15.0% to 55.0% by weight of stearic acid (C18:0), more preferably from 20.0% to 50.0% by weight, even more preferably from 23.0% to 45.0% by weight and most preferably from 25.0% to 40.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has from 25.0% to 68.0% by weight of total palmitic acid (C16:0) and stearic acid (C18:0), more preferably from 30.0% to 65.0% by weight, even more preferably from 40.0% to 62.0% by weight and most preferably from 50.0% to 60.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has from 20.0% to 50.0% by weight of oleic acid (C18:1), more preferably from 25.0% to 45.0% by weight, even more preferably from 25.0% to 40.0% by weight and most preferably from 27.0% to 35.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has at most 10.0% by weight of linoleic acid (C18:2), preferably from 0.5% to 8.0% by weight, more preferably from 1.0% to 6.0% by weight and even more preferably from 1.5% to 5.0% by weight; said percentages of acid referring to acids bound as acyl groups in glycerides of the plant-based fat phase and being based on the total weight of C8 to C24 fatty acids.

The plant-based fat phase in the confectionery product according to the invention preferably has a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 20.0% to 6.0%, more preferably from 30.0% to 55.0%, even more preferably from 35.0% to 50.0% and most preferably from 38.0% to 45.0%.

The plant-based fat phase in the confectionery product according to the invention preferably has a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 1.0% to 10.0%, more preferably from 1.5% to 7.0%, even more preferably from 2.0% to 6.0% and most preferably from 2.5% to 5.0%.

The plant-based fat phase in the confectionery product according to the invention preferably has a percentage of oleic acid (C18:1) on the second position of triglycerides out of total oleic acid (C18:1) (Sn-2 oleic acid %) in the triglycerides of the plant-based fat phase of from 55.0% to 90.0%, more preferably from 60.0% to 88.0%, even more preferably from 65.0% to 86.0% and most preferably from 70.0% to 83.0%.

In a preferred aspect, the plant-based fat phase in the confectionery product according to the invention has from 0.5% to 10% by weight of lauric acid (C12:0); at most 8.0% by weight of myristic acid (C14:0); from 1.5% to 9.0% by weight of total lauric acid (C12:0) and myristic acid (C14:0); from 10.0% to 50.0% by weight of palmitic acid (C16:0); from 15.0% to 55.0% by weight of stearic acid (C18:0); from 25.0% to 68.0% by weight of total palmitic acid (C16:0) and stearic acid (C18:0); from 20.0% to 50.0% by weight of oleic acid (C18:1); and at most 10.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 20.0% to 60.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 1.0% to 10.0%; and a percentage of oleic acid (C18:1) on the second position of triglycerides out of total oleic acid (C18:1) (Sn-2 oleic acid %) in the triglycerides of the plant-based fat phase of from 55.0% to 90.0%.

In a more preferred aspect, the plant-based fat phase in the confectionery product according to the invention has from 1.0% to 8.0% by weight of lauric acid (C12:0); from 0.1% to 6.0% by weight of myristic acid (C14:0); from 1.5% to 8.0% by weight of total lauric acid (C12:0) and myristic acid (C14:0); from 15.0% to 45.0% by weight of palmitic acid (C16:0); from 20.0% to 50.0% by weight of stearic acid (C18:0); from 30.0% to 65.0% by weight of total palmitic acid (C16:0) and stearic acid (C18:0); from 25.0% to 45.0% by weight of oleic acid (C18:1); and from 0.5% to 8.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 30.0% to 55.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 1.5% to 7.0%; and a percentage of oleic acid (C18:1) on the second position of triglycerides out of total oleic acid (C18:1) (Sn-2 oleic acid %) in the triglycerides of the plant-based fat phase of from 60.0% to 88.0%.

In an even more preferred aspect, the plant-based fat phase in the confectionery product according to the invention has from 1.0% to 6.5% by weight of lauric acid (C12:0); from 0.5% to 4.0% by weight of myristic acid (C14:0); from 2.0% to 7.5% by weight of total lauric acid (C12:0) and myristic acid (C14:0); from 18.0% to 40.0% by weight of palmitic acid (C16:0); from 23.0% to 45.0% by weight of stearic acid (C18:0); from 40.0% to 62.0% by weight of total palmitic acid (C16:0) and stearic acid (C18:0); from 25.0% to 40.0% by weight of oleic acid (C18:1); and from 1.0% to 6.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 35.0% to 50.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 2.0% to 6.0%; and a percentage of oleic acid (C18:1) on the second position of triglycerides out of total oleic acid (C18:1) (Sn-2 oleic acid %) in the triglycerides of the plant-based fat phase of from 65.0% to 86.0%.

In a most preferred aspect, the plant-based fat phase in the confectionery product according to the invention has from 1.1% to 5.0% by weight of lauric acid (C12:0); from 0.5% to 3.0% by weight of myristic acid (C14:0); from 2.0% to 7.0% by weight of total lauric acid (C12:0) and myristic acid (C14:0); from 20.0% to 35.0% by weight of palmitic acid (C16:0); from 25.0% to 40.0% by weight of stearic acid (C18:0); from 50.0% to 60.0% by weight of total palmitic acid (C16:0) and stearic acid (C18:0); from 27.0% to 35.0% by weight of oleic acid (C18:1); and from 1.5% to 5.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 38.0% to 45.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 2.5% to 5.0%; and a percentage of oleic acid (C18:1) on the second position of triglycerides out of total oleic acid (C18:1) (Sn-2 oleic acid %) in the triglycerides of the plant-based fat phase of from 70.0% to 83.0%.

The plant-based fat phase in the confectionery product according to the invention preferably has a content of trans fatty acid residues of less than 1.0% by weight, more preferably less than 0.5% by weight, even more preferably less than 0.2% by weight and most preferably at most 0.1% by weight.

The plant-based fat phase in the confectionery product according to the invention preferably comprises from 45.0% to 80.0% by weight of saturated fatty acid (SAFA), more preferably from 50.0% to 75.0% by weight, even more preferably from 55.0% to 70.0% by weight and most preferably from 60.0% to 65.0% by weight.

The plant-based fat phase in the confectionery product according to the invention preferably comprises from 15.0% to 50.0% by weight of mono-unsaturated fatty acid (MUFA), more preferably from 20.0% to 45.0% by weight, even more preferably from 25.0% to 40.0% by weight and most preferably from 30.0% to 35.0% by weight.

The plant-based fat phase in the confectionery product according to the invention preferably comprises from 0.0% to 12.0% by weight of poly-unsaturated fatty acid (PUFA), more preferably from 0.5% to 10.0% by weight, even more preferably from 1.0% to 8.0% by weight and most preferably from 1.0% to 5.0% by weight.

The plant-based fat phase in the confectionery product according to the invention preferably has an iodine value of from 20 to 50, more preferably from 25 to 45, even more preferably from 28 to 43 and most preferably from 30 to 40. The term “iodine value” refers to the number of grams of iodine that could be added to 100 g of oil. Iodine value may be calculated according to AOCS Cd 1c-85 based on total acids bound as acyl groups in glycerides in the fat composition being based on the total weight of C8 to C24 fatty acids. Iodine value may alternatively be measured by AOCS Method Cd 1-25.

The plant-based fat phase in the confectionery product according to the invention preferably has from 0.5% to 9.5% by weight of total CN32 triglycerides, CN34 triglycerides, CN36 triglycerides, CN38 triglycerides and CN40 triglycerides, more preferably from 1.0% to 9.0% by weight, even more preferably from 1.5% to 8.5% by weight and most preferably from 2.0% to 8.0% by weight; based on total triglycerides present in the plant-based fat phase.

The plant-based fat phase in the confectionery product according to the invention preferably has at most 5.0% by weight of CN42 triglycerides, more preferably from 0.5% to 4.5% by weight, even more preferably from 0.5% to 4.0% by weight and most preferably from 0.5% to 3.0% by weight; based on total triglycerides present in the plant-based fat phase.

The plant-based fat phase in the confectionery product according to the invention preferably has at least 3.0% by weight of total CN44 triglycerides, CN46 triglycerides and CN48 triglycerides, more preferably from 3.0% to 8.0% by weight, even more preferably from 3.5% to 7.0% by weight and most preferably from 3.5% to 6.0% by weight; based on total triglycerides present in the plant-based fat phase.

The plant-based fat phase in the confectionery product according to the invention preferably has from 5.0% to 38.0% by weight of CN50 triglycerides, more preferably from 8.0% to 35.0% by weight, even more preferably from 10.0% to 28.0% and most preferably from 11.0% to 27.0% by weight; based on total triglycerides present in the plant-based fat phase.

The plant-based fat phase in the confectionery product according to the invention preferably has from 25.0% to 50.0% by weight of CN52 triglycerides, more preferably from 28.0% to 45.0% by weight, even more preferably from 30.0% to 43.0% by weight and most preferably from 31.0% to 40.0% by weight; based on total triglycerides present in the plant-based fat phase.

The plant-based fat phase in the confectionery product according to the invention preferably has from 20.0% to 50.0% by weight of CN54 triglycerides, more preferably from 22.0% to 45.0% by weight, even more preferably from 23.0% to 43.0% by weight and most preferably from 25.0% to 40.0%; based on total triglycerides present in the plant-based fat phase.

In a preferred aspect, the plant-based fat phase in the confectionery product according to the invention has from 0.5% to 9.5% by weight of total CN32 triglycerides, CN34 triglycerides, CN36 triglycerides, CN38 triglycerides and CN40 triglycerides; at least 3.0% by weight of total CN44 triglycerides, CN46 triglycerides and CN48 triglycerides; from 5.0% to 38.0% by weight of CN50 triglycerides; from 25.0% to 50.0% by weight of CN52 triglycerides; and from 20.0% to 50.0% by weight of CN54 triglycerides; based on total triglycerides present in the plant-based fat phase.

In a more preferred aspect, the plant-based fat phase in the confectionery product according to the invention has from 1.0% to 9.0% by weight of total CN32 triglycerides, CN34 triglycerides, CN36 triglycerides, CN38 triglycerides and CN40 triglycerides; from 3.0% to 8.0% by weight of total CN44 triglycerides, CN46 triglycerides and CN48 triglycerides; from 8.0% to 35.0% by weight of CN50 triglycerides; from 28.0% to 45.0% by weight of CN52 triglycerides; and from 22.0% to 45.0% by weight of CN54 triglycerides; based on total triglycerides present in the plant-based fat phase.

In an even more preferred aspect, the plant-based fat phase in the confectionery product according to the invention has from 1.5% to 8.5% by weight of total CN32 triglycerides, CN34 triglycerides, CN36 triglycerides, CN38 triglycerides and CN40 triglycerides; from 3.5% to 7.0% by weight of total CN44 triglycerides, CN46 triglycerides and CN48 triglycerides; from 10.0% to 28.0% by weight of CN50 triglycerides; from 30.0% to 43.0% by weight of CN52 triglycerides; and from 23.0% to 43.0% by weight of CN54 triglycerides; based on total triglycerides present in the plant-based fat phase.

In a most preferred aspect, the plant-based fat phase in the confectionery product according to the invention has from 2.0% to 8.0% by weight of total CN32 triglycerides, CN34 triglycerides, CN36 triglycerides, CN38 triglycerides and CN40 triglycerides; from 3.5% to 6.0% by weight of total CN44 triglycerides, CN46 triglycerides and CN48 triglycerides; from 11.0% to 27.0% by weight of CN50 triglycerides; from 31.0% to 40.0% by weight of CN52 triglycerides; and from 25.0% to 40.0% by weight of CN54 triglycerides; based on total triglycerides present in the plant-based fat phase.

The plant-based fat phase in the confectionery product according to the invention preferably has from 45.0 to 90.0 solid fat content at 10° C., more preferably from 50.0 to 85.0, even more preferably from 55.0 to 83.0 and most preferably from 60.0 to 80.0; measured on fat stabilized at 26° C. for 40 hours according to ISO 8292-1:2008.

The plant-based fat phase in the confectionery product according to the invention preferably has from 30.0 to 75.0 solid fat content at 20° C., more preferably from 35.0 to 65.0, even more preferably from 40.0 to 60.0 and most preferably from 42.0 to 58.0; measured on fat stabilized at 26° C. for 40 hours according to ISO 8292-1:2008.

The plant-based fat phase in the confectionery product according to the invention preferably has from 20.0 to 65.0 solid fat content at 25° C., more preferably from 25.0 to 55.0, even more preferably from 28.0 to 52.0 and most preferably from 30.0 to 50.0; measured on fat stabilized at 26° C. for 40 hours according to ISO 8292-1:2008.

The plant-based fat phase in the confectionery product according to the invention preferably has from 5.0 to 40.0 solid fat content at 30° C., more preferably from 8.0 to 30.0, even more preferably from 10.0 to 28.0 and most preferably from 12.0 to 25.0; measured on fat stabilized at 26° C. for 40 hours according to ISO 8292-1:2008.

In a preferred aspect, the plant-based fat phase in the confectionery product according to the invention has from 45.0 to 90.0 solid fat content at 10° C.; from 30.0 to 75.0 solid fat content at 20° C.; from 20.0 to 65.0 solid fat content at 25° C.; and from 5.0 to 40.0 solid fat content at 30° C.; measured on fat stabilized at 26° C. for 40 hours according to ISO 8292-1:2008.

In a more preferred aspect, the plant-based fat phase in the confectionery product according to the invention has from 50.0 to 85.0 solid fat content at 10° C.; from 35.0 to 65.0 solid fat content at 20° C.; from 25.0 to 55.0 solid fat content at 25° C.; and from 8.0 to 30.0 solid fat content at 30° C.; measured on fat stabilized at 26° C. for 40 hours according to ISO 8292-1:2008.

In an even more preferred aspect, the plant-based fat phase in the confectionery product according to the invention has from 55.0 to 83.0 solid fat content at 10° C.; from 40.0 to 60.0 solid fat content at 20° C.; from 28.0 to 52.0 solid fat content at 25° C.; and from 10.0 to 28.0 solid fat content at 30° C.; measured on fat stabilized at 26° C. for 40 hours according to ISO 8292-1:2008.

In a most preferred aspect, the plant-based fat phase in the confectionery product according to the invention has from 60.0 to 80.0 solid fat content at 10° C.; from 42.0 to 58.0 solid fat content at 20° C.; from 30.0 to 50.0 solid fat content at 25° C.; and from 12.0 to 25.0 solid fat content at 30° C.; measured on fat stabilized at 26° C. for 40 hours according to ISO 8292-1:2008.

The plant-based fat phase in the confectionery product according to the invention preferably has from 0.5% to 5.0% by weight of diglycerides, more preferably from 1.0% to 4.0% by weight and even more preferably from 1.5% to 3.5% by weight.

The plant-based fat phase in the confectionery product according to the invention preferably has at most 2.0% by weight of 1,2-diglycerides, more preferably from 0.1% to 1.5% by weight and even more preferably from 0.5% to 1.0% by weight.

The plant-based fat phase in the confectionery product according to the invention preferably has at most 3.0% by weight of 1,3-diglycerides, more preferably from 0.5% to 3.0% by weight and even more preferably from 1.0% to 2.5% by weight.

The term “diglyceride” refers to a glyceride consisting of two fatty acid chains covalently bonded to a glycerol molecule, not necessarily limited to specific positions on the glycerol backbone (1,3- or 2-positions). The term “1,2-diglyceride” refers to a glyceride consisting of two fatty acid chains covalently bonded to a glycerol molecule limited to 1,2 specific position on the glycerol backbone. The term “1,3-diglyceride” refers to a glyceride consisting of two fatty acid chains covalently bonded to a glycerol molecule limited to 1,3 specific position on the glycerol backbone.

In a preferred aspect, the plant-based fat phase in the confectionery product according to the invention has from 0.5% to 5.0% by weight of diglycerides; at most 2.0% by weight of 1,2-diglycerides; and at most 3.0% by weight of 1,3-diglycerides.

In a more preferred aspect, the plant-based fat phase in the confectionery product according to the invention has from 1.0% to 4.0% by weight of diglycerides; from 0.1% to 1.5% by weight of 1,2-diglycerides; and from 0.5% to 3.0% by weight of 1,3-diglycerides.

In an even more preferred aspect, the plant-based fat phase in the confectionery product according to the invention has from 1.5% to 3.5% by weight of diglycerides; from 0.5% to 1.0% by weight of 1,2-diglycerides; and from 1.0% to 2.5% by weight of 1,3-diglycerides.

In a preferred aspect, the plant-based fat phase in the confectionery product according to the invention has from 0.5% to 10% by weight of lauric acid (C12:0); at most 8.0% by weight of myristic acid (C14:0); from 1.5% to 9.0% by weight of total lauric acid (C12:0) and myristic acid (C14:0); from 10.0% to 50.0% by weight of palmitic acid (C16:0); from 15.0% to 55.0% by weight of stearic acid (C18:0); from 25.0% to 68.0% by weight of total palmitic acid (C16:0) and stearic acid (C18:0); from 20.0% to 50.0% by weight of oleic acid (C18:1); and at most 10.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 20.0% to 60.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 1.0% to 10.0%; and a percentage of oleic acid (C18:1) on the second position of triglycerides out of total oleic acid (C18:1) (Sn-2 oleic acid %) in the triglycerides of the plant-based fat phase of from 55.0% to 90.0%; from 0.5% to 9.5% by weight of total CN32 triglycerides, CN34 triglycerides, CN36 triglycerides, CN38 triglycerides and CN40 triglycerides; at least 3.0% by weight of total CN44 triglycerides, CN46 triglycerides and CN48 triglycerides; from 5.0% to 38.0% by weight of CN50 triglycerides; from 25.0% to 50.0% by weight of CN52 triglycerides; and from 20.0% to 50.0% by weight of CN54 triglycerides; based on total triglycerides present in the plant-based fat phase; from 45.0 to 90.0 solid fat content at 10° C.; from 30.0 to 75.0 solid fat content at 20° C.; from 20.0 to 65.0 solid fat content at 25° C.; and from 5.0 to 40.0 solid fat content at 30° C.; measured on fat stabilized at 26° C. for 40 hours according to ISO 8292-1:2008.

In a more preferred aspect, the plant-based fat phase in the confectionery product according to the invention has from 1.0% to 8.0% by weight of lauric acid (C12:0); from 0.1% to 6.0% by weight of myristic acid (C14:0); from 1.5% to 8.0% by weight of total lauric acid (C12:0) and myristic acid (C14:0); from 15.0% to 45.0% by weight of palmitic acid (C16:0); from 20.0% to 50.0% by weight of stearic acid (C18:0); from 30.0% to 65.0% by weight of total palmitic acid (C16:0) and stearic acid (C18:0); from 25.0% to 45.0% by weight of oleic acid (C18:1); and from 0.5% to 8.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 30.0% to 55.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 1.5% to 7.0%; and a percentage of oleic acid (C18:1) on the second position of triglycerides out of total oleic acid (C18:1) (Sn-2 oleic acid %) in the triglycerides of the plant-based fat phase of from 60.0% to 88.0%; from 1.0% to 9.0% by weight of total CN32 triglycerides, CN34 triglycerides, CN36 triglycerides, CN38 triglycerides and CN40 triglycerides; from 3.0% to 8.0% by weight of total CN44 triglycerides, CN46 triglycerides and CN48 triglycerides; from 8.0% to 35.0% by weight of CN50 triglycerides; from 28.0% to 45.0% by weight of CN52 triglycerides; and from 22.0% to 45.0% by weight of CN54 triglycerides; based on total triglycerides present in the plant-based fat phase; from 50.0 to 85.0 solid fat content at 10° C.; from 35.0 to 65.0 solid fat content at 20° C.; from 25.0 to 55.0 solid fat content at 25° C.; and from 8.0 to 30.0 solid fat content at 30° C.; measured on fat stabilized at 26° C. for 40 hours according to ISO 8292-1:2008; from 0.5% to 5.0% by weight of diglycerides; at most 2.0% by weight of 1,2-diglycerides; and at most 3.0% by weight of 1,3-diglycerides.

In an even more preferred aspect, the plant-based fat phase in the confectionery product according to the invention has from 1.0% to 6.5% by weight of lauric acid (C12:0); from 0.5% to 4.0% by weight of myristic acid (C14:0); from 2.0% to 7.5% by weight of total lauric acid (C12:0) and myristic acid (C14:0); from 18.0% to 40.0% by weight of palmitic acid (C16:0); from 23.0% to 45.0% by weight of stearic acid (C18:0); from 40.0% to 62.0% by weight of total palmitic acid (C16:0) and stearic acid (C18:0); from 25.0% to 40.0% by weight of oleic acid (C18:1); and from 1.0% to 6.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 35.0% to 50.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 2.0% to 6.0%; and a percentage of oleic acid (C18:1) on the second position of triglycerides out of total oleic acid (C18:1) (Sn-2 oleic acid %) in the triglycerides of the plant-based fat phase of from 65.0% to 86.0%; from 1.5% to 8.5% by weight of total CN32 triglycerides, CN34 triglycerides, CN36 triglycerides, CN38 triglycerides and CN40 triglycerides; from 3.5% to 7.0% by weight of total CN44 triglycerides, CN46 triglycerides and CN48 triglycerides; from 10.0% to 28.0% by weight of CN50 triglycerides; from 30.0% to 43.0% by weight of CN52 triglycerides; and from 23.0% to 43.0% by weight of CN54 triglycerides; based on total triglycerides present in the plant-based fat phase; from 55.0 to 83.0 solid fat content at 10° C.; from 40.0 to 60.0 solid fat content at 20° C.; from 28.0 to 52.0 solid fat content at 25° C.; and from 10.0 to 28.0 solid fat content at 30° C.; measured on fat stabilized at 26° C. for 40 hours according to ISO 8292-1:2008; from 1.0% to 4.0% by weight of diglycerides; from 0.1% to 1.5% by weight of 1,2-diglycerides; and from 0.5% to 3.0% by weight of 1,3-diglycerides.

In a most preferred aspect, the plant-based fat phase in the confectionery product according to the invention has from 1.1% to 5.0% by weight of lauric acid (C12:0); from 0.5% to 3.0% by weight of myristic acid (C14:0); from 2.0% to 7.0% by weight of total lauric acid (C12:0) and myristic acid (C14:0); from 20.0% to 35.0% by weight of palmitic acid (C16:0); from 25.0% to 40.0% by weight of stearic acid (C18:0); from 50.0% to 60.0% by weight of total palmitic acid (C16:0) and stearic acid (C18:0); from 27.0% to 35.0% by weight of oleic acid (C18:1); and from 1.5% to 5.0% by weight of linoleic acid (C18:2); said percentages of acid referring to acids bound as acyl groups in glycerides of the plant-based fat phase and being based on the total weight of C8 to C24 fatty acids; a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 38.0% to 45.0%; a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 2.5% to 5.0%; and a percentage of oleic acid (C18:1) on the second position of triglycerides out of total oleic acid (C18:1) (Sn-2 oleic acid %) in the triglycerides of the plant-based fat phase of from 70.0% to 83.0%; from 2.0% to 8.0% by weight of total CN32 triglycerides, CN34 triglycerides, CN36 triglycerides, CN38 triglycerides and CN40 triglycerides; from 3.5% to 6.0% by weight of total CN44 triglycerides, CN46 triglycerides and CN48 triglycerides; from 11.0% to 27.0% by weight of CN50 triglycerides; from 31.0% to 40.0% by weight of CN52 triglycerides; and from 25.0% to 40.0% by weight of CN54 triglycerides; based on total triglycerides present in the plant-based fat phase; from 60.0 to 80.0 solid fat content at 10° C.; from 42.0 to 58.0 solid fat content at 20° C.; from 30.0 to 50.0 solid fat content at 25° C.; and from 12.0 to 25.0 solid fat content at 30° C.; measured on fat stabilized at 26° C. for 40 hours according to ISO 8292-1:2008; from 1.5% to 3.5% by weight of diglycerides; from 0.5% to 1.0% by weight of 1,2-diglycerides; and from 1.0% to 2.5% by weight of 1,3-diglycerides.

The plant-based fat phase in the confectionery product according to the invention preferably comprises from 3% to 20% by weight, more preferably from 5% to 18% by weight and even more preferably from 5% to 15% by weight of an interesterified fat blend comprising at least a lauric fat. Preferably the lauric fat in the interesterified fat blend as disclosed herein is selected from a group consisting of coconut oil, palm kernel oil, a fraction thereof and a mixture thereof. Preferably the lauric fat in the interesterified fat blend as disclosed herein is present in an amount of from 30% to 80% by weight, more preferably from 35% to 75% by weight, based on the weight of the interesterified fat blend.

The term “lauric fat” refers to a fat containing mainly lauric acid (C12:0) such as at least 30% by weight of lauric acid (C12:0), typically derived from sources such as coconut oil or palm kernel oil.

The term “interesterified fat” refers to a fat subjected to a random non-specific redistribution of the fatty acid moieties present in a triglyceride oil over its glycerol moieties.

In a preferred aspect, the plant-based fat phase in the confectionery product according to the invention comprises from 3% to 20% by weight of an interesterified fat blend wherein the interesterified fat blend comprises from 30% to 80% by weight of a lauric fat and 20% to 70% of a fat selected from a group consisting of cocoa butter, shea butter, palm oil, illipe butter, mango oil, sal butter, kokum oil, a fraction thereof and a mixture thereof.

In a more preferred aspect, the plant-based fat phase in the confectionery product according to the invention comprises from 5% to 18% by weight of an interesterified fat blend wherein the interesterified fat blend comprises from 35% to 75% by weight of a lauric fat and 25% to 65% of a fat selected from a group consisting of cocoa butter, shea butter, palm oil, illipe butter, mango oil, sal butter, kokum oil, a fraction thereof and a mixture thereof.

In an even more preferred aspect, the plant-based fat phase in the confectionery product according to the invention comprises from 5% to 15% by weight of an interesterified fat blend wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof.

The plant-based fat phase in the confectionery product according to the invention preferably further comprises from 3% to 15% by weight, preferably from 5% to 10% by weight of a liquid oil, preferably wherein the liquid oil is selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof, more preferably wherein the liquid oil is selected from the group consisting of sunflower oil, high oleic sunflower oil, palm olein, rapeseed oil, a fraction thereof and a mixture thereof. The term “liquid oil” refers to any oil which is liquid or fluid at room temperature such as from 20° C. to 25° C.

In a preferred aspect, the plant-based fat phase in the confectionery product according to the invention comprises from 3% to 15% by weight of a liquid oil and from 3% to 20% by weight of an interesterified fat blend wherein the interesterified fat blend comprises from 30% to 80% by weight of a lauric fat and 20% to 70% of a fat selected from a group consisting of cocoa butter, shea butter, palm oil, illipe butter, mango oil, sal butter, kokum oil, a fraction thereof and a mixture thereof.

In a more preferred aspect, the plant-based fat phase in the confectionery product according to the invention comprises from 5% to 10% by weight of a liquid oil selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof and from 5% to 18% by weight of an interesterified fat blend wherein the interesterified fat blend comprises from 35% to 75% by weight of a lauric fat and 25% to 65% of a fat selected from a group consisting of cocoa butter, shea butter, palm oil, illipe butter, mango oil, sal butter, kokum oil, a fraction thereof and a mixture thereof.

In an even more preferred aspect, the plant-based fat phase in the confectionery product according to the invention comprises from 5% to 10% by weight of a liquid oil selected from the group consisting of sunflower oil, high oleic sunflower oil, palm olein, rapeseed oil, a fraction thereof and a mixture thereof and from 5% to 15% by weight of an interesterified fat blend wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof.

In a preferred aspect, the plant-based fat phase in the confectionery product comprises from 3% to 20% by weight of an interesterified fat blend wherein the interesterified fat blend consists of from 30% to 80% by weight of a lauric fat and 20% to 70% by weight of a fat selected from a group consisting of cocoa butter, shea butter, palm oil, illipe butter, mango oil, sal butter, kokum oil, a fraction thereof and a mixture thereof based on the total weight of the interesterified fat blend; and from 3% to 15% by weight of a liquid oil.

In a more preferred aspect, the plant-based fat phase in the confectionery product comprises from 5% to 18% by weight of an interesterified fat blend wherein the interesterified fat blend consists of from 35% to 75% by weight of a lauric fat selected from a group consisting of coconut oil, palm kernel oil, a fraction thereof and a mixture thereof and 25% to 65% by weight of a fat selected from a group consisting of cocoa butter, shea butter, palm oil, illipe butter, mango oil, sal butter, kokum oil, a fraction thereof and a mixture thereof based on the total weight of the interesterified fat blend; and from 5% to 10% by weight of a liquid oil selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof.

The plant-based fat phase in the confectionery product according to the invention preferably further comprises from 65% to 94% by weight of cocoa butter or cocoa butter equivalent or a mixture thereof, more preferably from 72% to 90% by weight and even more preferably from 75% to 90% by weight. The term “cocoa butter equivalent” as well known in the art, refers to specialty fats containing the same fatty acids and symmetrical mono-unsaturated triglycerides as cocoa butter which are fully compatible with cocoa butter and can be mixed with cocoa butter in any ratio in the confectionery products.

In a preferred aspect, the plant-based fat phase in the confectionery product according to the invention comprises from 65% to 94% by weight of cocoa butter or cocoa butter equivalent or a mixture thereof; from 3% to 15% by weight of a liquid oil and from 3% to 20% by weight of an interesterified fat blend wherein the interesterified fat blend comprises from 30% to 80% by weight of a lauric fat and 20% to 70% of a fat selected from a group consisting of cocoa butter, shea butter, palm oil, illipe butter, mango oil, sal butter, kokum oil, a fraction thereof and a mixture thereof.

In a more preferred aspect, the plant-based fat phase in the confectionery product according to the invention comprises from 72% to 90% by weight of cocoa butter or cocoa butter equivalent or a mixture thereof; from 5% to 10% by weight of a liquid oil selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof and from 5% to 18% by weight of an interesterified fat blend wherein the interesterified fat blend comprises from 35% to 75% by weight of a lauric fat and 25% to 65% of a fat selected from a group consisting of cocoa butter, shea butter, palm oil, illipe butter, mango oil, sal butter, kokum oil, a fraction thereof and a mixture thereof.

In an even more preferred aspect, the plant-based fat phase in the confectionery product according to the invention comprises from 75% to 90% by weight of cocoa butter or cocoa butter equivalent or a mixture thereof; from 5% to 10% by weight of a liquid oil selected from the group consisting of sunflower oil, high oleic sunflower oil, palm olein, rapeseed oil, a fraction thereof and a mixture thereof and from 5% to 15% by weight of an interesterified fat blend wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof.

In a most preferred aspect, the plant-based fat phase in the confectionery product according to the invention consists of from 75% to 90% by weight of cocoa butter or cocoa butter equivalent or a mixture thereof; from 5% to 10% by weight of a liquid oil selected from the group consisting of sunflower oil, high oleic sunflower oil, palm olein, rapeseed oil, a fraction thereof and a mixture thereof and from 5% to 15% by weight of an interesterified fat blend wherein the interesterified fat blend consists of from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof.

In a preferred aspect, the plant-based fat phase in the confectionery product consists of from 5% to 18% by weight of an interesterified fat blend wherein the interesterified fat blend consists of from 35% to 75% by weight of a lauric fat selected from a group consisting of coconut oil, palm kernel oil, a fraction thereof and a mixture thereof and 25% to 65% by weight of a fat selected from a group consisting of cocoa butter, shea butter, palm oil, illipe butter, mango oil, sal butter, kokum oil, a fraction thereof and a mixture thereof based on the total weight of the interesterified fat blend; from 5% to 10% by weight of a liquid oil selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof; and from 72% to 90% by weight of a fat containing at least 40% by weight of SOS triglycerides based on the total glycerides present in the fat, wherein S is saturated acid and O is oleic acid.

In a more preferred aspect, the plant-based fat phase in the confectionery product consists of from 5% to 15% by weight of an interesterified fat blend wherein the interesterified fat blend consists of from 35% to 75% by weight of a lauric fat selected from a group consisting of coconut oil, palm kernel oil, a fraction thereof and a mixture thereof and 25% to 65% by weight of a fat selected from a group consisting of cocoa butter, shea butter, palm oil, illipe butter, mango oil, sal butter, kokum oil, a fraction thereof and a mixture thereof based on the total weight of the interesterified fat blend; from 5% to 10% by weight of a liquid oil selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof; and from 75% to 90% by weight of a fat containing from 40% to 90% by weight of SOS triglycerides based on the total glycerides present in the fat, wherein S is saturated acid and O is oleic acid.

The invention also relates to a process for preparing the confectionery product according to the invention comprising the steps of: a) providing an interesterified fat blend comprising at least a lauric fat; b) providing a liquid oil; c) mixing the interesterified fat blend, the liquid oil, a sweetener, optionally water, optionally one or more ingredients selected from cocoa powder, cocoa mass, skimmed milk powder, vanillin, emulsifier, colorant and flavoring, and optionally a plant milk power; and d) processing the mixture to form the confectionery product according to the invention.

In a preferred aspect, the process for preparing the confectionery product according to the invention comprising the steps of: a) providing an interesterified fat blend comprising at least a lauric fat, wherein the interesterified fat blend comprises from 30% to 80% by weight of a lauric fat and 20% to 70% of a fat selected from a group consisting of cocoa butter, shea butter, palm oil, illipe butter, mango oil, sal butter, kokum oil, a fraction thereof and a mixture thereof; b) providing a liquid oil; c) mixing the interesterified fat blend, the liquid oil, a sweetener, optionally water, optionally one or more ingredients selected from cocoa powder, cocoa mass, skimmed milk powder, vanillin, emulsifier, colorant and flavoring, and optionally a plant milk power; and d) processing the mixture to form the confectionery product according to the invention.

In a more preferred aspect, the process for preparing the confectionery product according to the invention comprising the steps of: a) providing an interesterified fat blend comprising at least a lauric fat, wherein the interesterified fat blend comprises from 35% to 75% by weight of a lauric fat and 25% to 65% of a fat selected from a group consisting of cocoa butter, shea butter, palm oil, illipe butter, mango oil, sal butter, kokum oil, a fraction thereof and a mixture thereof; b) providing a liquid oil; c) mixing the interesterified fat blend, the liquid oil, a sweetener, optionally water, optionally one or more ingredients selected from cocoa powder, cocoa mass, skimmed milk powder, vanillin, emulsifier, colorant and flavoring, and optionally a plant milk power; and d) processing the mixture to form the confectionery product according to the invention.

In an even more preferred aspect, the process for preparing the confectionery product according to the invention comprising the steps of: a) providing an interesterified fat blend comprising at least a lauric fat, wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof; b) providing a liquid oil; c) mixing the interesterified fat blend, the liquid oil, a sweetener, optionally water, optionally one or more ingredients selected from cocoa powder, cocoa mass, skimmed milk powder, vanillin, emulsifier, colorant and flavoring, and optionally a plant milk power; and d) processing the mixture to form the confectionery product according to the invention.

In another preferred aspect, the process for preparing the confectionery product according to the invention wherein the confectionery product is a chocolate, a chocolate-like product or a coating, comprising the steps of: a) providing an interesterified fat blend comprising at least a lauric fat, wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof; b) providing a liquid oil; c) mixing the interesterified fat blend, the liquid oil, a sweetener, optionally water, optionally one or more ingredients selected from cocoa powder, cocoa mass, skimmed milk powder, vanillin, emulsifier, colorant and flavoring, and optionally a plant milk power; and d) processing the mixture to form the confectionery product according to the invention.

In another more preferred aspect, the process for preparing the confectionery product according to the invention wherein the confectionery product is a chocolate, a chocolate-like product or a coating, comprising the steps of: a) providing an interesterified fat blend comprising at least a lauric fat, wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof; b) providing a liquid oil; c) mixing the interesterified fat blend, the liquid oil, a sweetener, one or more ingredients selected from cocoa powder, cocoa mass, skimmed milk powder, vanillin, emulsifier and colorant, at most 0.05% by weight of butter flavoring, optionally water, and optionally a plant milk power; and d) processing the mixture to form the confectionery product according to the invention.

In yet another preferred aspect, the process for preparing the confectionery product according to the invention wherein the confectionery product is a chocolate, a chocolate-like product or a coating, comprising the steps of: a) providing an interesterified fat blend comprising at least a lauric fat, wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof; b) providing a liquid oil; c) mixing the interesterified fat blend, the liquid oil, a sweetener, one or more ingredients selected from cocoa powder, cocoa mass, skimmed milk powder, vanillin, emulsifier, colorant and flavoring, and oat milk powder, and optionally water; and d) processing the mixture to form the confectionery product according to the invention.

In yet another more preferred aspect, the process for preparing the confectionery product according to the invention wherein the confectionery product is a chocolate, a chocolate-like product or a coating, comprising the steps of: a) providing an interesterified fat blend comprising at least a lauric fat, wherein the interesterified fat blend comprises from 35% to 75% by weight of a lauric fat selected from a group consisting of coconut oil, palm kernel oil, a fraction thereof and a mixture thereof and 25% to 65% of a fat selected from a group consisting of cocoa butter, shea butter, palm oil, a fraction thereof and a mixture thereof; b) providing a liquid oil; c) mixing the interesterified fat blend, the liquid oil, a sweetener, one or more ingredients selected from cocoa powder, cocoa mass, skimmed milk powder, vanillin, emulsifier and colorant, at most 0.05% by weight of butter flavoring and from 0.001% to 0.050% by weight of oat milk powder, and optionally water; and d) processing the mixture to form the confectionery product according to the invention.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

As will be understood by one skilled in the art, for any and all purposes, particularly in terms of providing a written description, all ranges disclosed herein also encompass any and all possible subranges and combinations of subranges thereof. Any listed ranges can be easily recognized as sufficiently describing and enabling the same range being broken down into at least equal halves, thirds, quarters, fifths, tenths, etc. As will also be understood by one skilled in the art all language such as “up to”, “at least”, “greater than”, “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The following non-limiting examples illustrate the invention and do not limit its scope in any way. In the examples and throughout this specification, all percentages, parts and ratios are by weight unless indicated otherwise.

### EXAMPLES

Throughout these examples:
US-Nx refers to solid fat content determined by NMR on unstabilised fat measured at x° C. (ISO 8292-1:2008);
S26Nx refers to solid fat content determined by NMR on stabilized fat (stabilized at 26° C. for 40 hours) measured at x° C. (ISO 8292-1:2008);
Cx:y refers to a fatty acid having x carbon atoms and y double bonds; levels determined by GC-FAME (ISO 12966-2:2014 and ISO 12966-4:2015);
percentages of acid referring to acids bound as acyl groups in glycerides and being
based on the total weight of C8 to C24 fatty acids;
SAFA refers to saturated fatty acids;
MUFA refers to mono-unsaturated fatty acids;
PUFA refers to poly-unsaturated fatty acids;
IV FAME refers to calculated iodine value according to AOCS Cd 1c-85;
TRANS refers to trans fatty acids: unsaturated fatty acids having a double bond in a trans arrangement;
Triglyceride compositions, POP, POSt, StOSt and other triglycerides were determined by GC (ISO 23275:2006), wherein each GC peak includes triglycerides having the same fatty acids in different positions e.g., POSt is in the same signal peak as PStO and StOP. SOS triglycerides include any triglyceride containing two saturated fatty acids and one oleic acid such as POP, POSt or StOSt. O, P, St and S refer to oleic, palmitic, stearic and saturated acids, respectively;
Diglyceride refers to the percentage of diglyceride or diacylglycerol (DAG) in the composition measured by straight phase HPLC and two forms of diglycerides exist, 1,2-diglyceride (1,2-diacylglycerols) and 1,3-diglyceride (1,3-diacylglycerols); CNxx, refers to a triglyceride having xx carbon atoms (excluding the carbon atoms from the glycerol, as is standard practice), levels determined by GC with pre-treatment to remove the diglycerides eventually (AOCS Ce 5-86); SN-2 of total lauric acid and myristic acid % refers to the percentage of total lauric acid (C12:0) and myristic acid (C14:0) present at the 2-position of the triglyceride in comparison to the percentage of total lauric acid (C12:0) and myristic acid (C14:0) in the fat sample. The distribution of fatty acids in triglyceride is determined based on joint JOCS/AOCS official method Ch 3a-19. The percentage of total lauric acid (C12:0) and myristic acid (C14:0) residues in the 2-position is determined by finding: (a) the total lauric acid (C12:0) and myristic acid (C14:0) content of the fat sample by GC-FAME (ISO 12966-2:2014 and ISO 12966-4:2015) being based on the total weight of C8 to C24 fatty acids; and (b) the total lauric acid (C12:0) and myristic acid (C14:0) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of total lauric acid and myristic acid % is thus ((b)×100)/((a)×3) %;
SN-2 of total palmitic acid and stearic acid % refers to the percentage of total palmitic acid (C16:0) and stearic acid (C18:0) present at the 2-position of the triglyceride in comparison to the percentage of total palmitic acid (C16:0) and stearic acid (C18:0) in the fat sample. The distribution of fatty acids in triglyceride is determined based on joint JOCS/AOCS official method Ch 3a-19. The percentage of total palmitic acid (C16:0) and stearic acid (C18:0) residues in the 2-position is determined by finding: (a) the total palmitic acid (C16:0) and stearic acid (C18:0) content of the fat sample by GC-FAME (ISO 12966-2:2014 and ISO 12966-4:2015) being based on the total weight of C8 to C24 fatty acids; and (b) the total palmitic acid (C16:0) and stearic acid (C18:0) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of total palmitic acid and stearic acid % is thus ((b)×100)/((a)×3) %; and
SN-2 of oleic acid % refers to the percentage of oleic acid (C18:1) present at the 2-position of the triglyceride in comparison to the percentage of oleic acid (C18:1) in the fat sample. The distribution of fatty acids in triglyceride is determined based on joint JOCS/AOCS official method Ch 3a-19. The percentage of oleic acid (C18:1) residues in the 2-position is determined by finding: (a) the oleic acid (C18:1) content of the fat sample by GC-FAME (ISO 12966-2:2014 and ISO 12966-4:2015) being based on the total weight of C8 to C24 fatty acids; and (b) the oleic acid (C18:1) content of the 2-position by GC-FAME (ISO 12966-2:2014 and ISO 12966-4:2015) in 2-monoglyceride being based on the total weight of C8 to C24 fatty acids after the transesterification reaction of triacylglycerols with ethanol by immobilized lipase and the isolation with preparative straight phase HPLC. The Sn-2 of oleic acid % is thus ((b)×100)/((a)×3) %.

### Example 1—Preparation of Fat Compositions 1, 2 and 3

A fat blend of 25% by weight of refined cocoa butter and 75% by weight of coconut oil was chemically interesterified using sodium methoxide as catalyst followed by refining including bleaching and deodorization to form a interesterified fat blend A as hardstock. Fat composition 1 was a blend of 64% by weight of the interesterified fat blend A, 14% by weight of coconut oil and 22% by weight of high oleic sunflower oil.

A fat blend of 35% by weight of refined palm kernel oil and 65% by weight of palm stearin with iodine value of about 35 was enzymatically interesterified using Lipozyme® TL IM as catalyst followed by refining including bleaching and deodorization to form a interesterified fat blend B as hardstock. Fat composition 2 was a blend of 40% by weight of the interesterified fat blend B and 60% by weight of palm olein with iodine value of about 56.

A fat blend of 40% by weight of refined coconut oil and 60% by weight of refined shea butter was chemically interesterified using sodium methoxide as catalyst followed by refining including bleaching and deodorization to form a interesterified fat blend C as hardstock. Fat composition 3 was a blend of 67.5% by weight of the interesterified fat blend C, 22.5% by weight of coconut oil and 10% by weight of sunflower oil.

The analytical results of Fat composition 1, Fat composition 2 and Fat composition 3 are shown in Table 1.

TABLE 1
Analytical results of Fat composition 1, Fat composition 2 and Fat
composition 3.

| | Fat composition 1 | Fat composition 2 | Fat composition 3 |
|---|---|---|---|
| US-N10 | 50.0 | 52.3 | 52.8 |
| US-N20 | 21.1 | 23.7 | 21.0 |
| US-N25 | 7.8 | 13.4 | 8.7 |
| US-N30 | 0.5 | 6.8 | 3.0 |
| US-N35 | 0.0 | 2.0 | 0.9 |
| C8:0 | 4.1 | 0.5 | 3.3 |
| C10:0 | 3.4 | 0.5 | 2.8 |
| C12:0 | 27.5 | 6.6 | 22.7 |
| C14:0 | 11.0 | 3.1 | 9.1 |
| C16:0 | 10.9 | 40.7 | 7.4 |
| C16:1 | 0.1 | 0.1 | 0.0 |
| C17:0 | 0.1 | 0.1 | 0.0 |
| C18:0 | 8.7 | 4.4 | 18.7 |
| C18:1 | 29.7 | 34.6 | 30.8 |
| C18:2 | 3.6 | 8.5 | 3.8 |
| C18:3 | 0.1 | 0.2 | 0.1 |
| C20:0 | 0.4 | 0.3 | 0.7 |
| C20:1 | 0.1 | 0.1 | 0.2 |
| C22:0 | 0.3 | 0.1 | 0.2 |
| C24:0 | 0.1 | 0.1 | 0.1 |
| SAFA | 66.4 | 56.4 | 65.1 |
| MUFA | 29.9 | 34.9 | 31.1 |
| PUFA | 3.7 | 8.7 | 3.9 |
| IV FAME | 32.1 | 45.3 | 33.5 |
| TRANS | 0.1 | 0.2 | 0.1 |
| CN26 | 0.2 | 0.1 | 0.2 |
| CN28 | 0.6 | 0.1 | 0.3 |
| CN30 | 1.6 | 0.3 | 1.4 |
| CN32 | 4.4 | 0.2 | 3.1 |
| CN34 | 5.9 | 0.4 | 4.3 |
| CN36 | 9.1 | 1.2 | 6.2 |
| CN38 | 10.1 | 1.3 | 7.4 |
| CN40 | 9.0 | 3.0 | 6.4 |
| CN42 | 11.2 | 3.6 | 10.4 |
| CN44 | 7.7 | 5.7 | 8.4 |
| CN46 | 5.9 | 7.0 | 6.4 |
| CN48 | 5.6 | 8.2 | 14.3 |
| CN50 | 2.8 | 29.3 | 6.5 |
| CN52 | 4.9 | 30.6 | 6.1 |
| CN54 | 20.0 | 8.7 | 18.3 |
| CN56 | 0.6 | 0.4 | 0.3 |
| CN58 | 0.5 | 0.0 | 0.0 |
| Diglyceride | 3.0 | 6.7 | 4.3 |
| 1,2- | 1.0 | 2.3 | 1.4 |
| diglyceride | | | |
| 1,3- | 2.0 | 4.4 | 2.9 |
| diglyceride | | | |

### Example 2—Production and Recipe of Milk Chocolate-Like Products

Besides the three fat compositions as prepared in Example 1, anhydrous milk fat (commercially available from Friesland Campina), cocoa butter (commercially available from Barry Callebaut) (containing 82% by weight of SOS triglycerides), soft cocoa butter equivalent (CBE) (obtainable from Bunge Loders Croklaan) (containing 58% by weight of SOS triglycerides), hard cocoa butter equivalent (CBE) (obtainable from Bunge Loders Croklaan) (containing 80% by weight of SOS triglycerides) and refined shea butter (containing 45% by weight of SOS triglycerides) were used for the following tests. The percentages of SOS triglycerides are based on the total glycerides in the corresponding fat, wherein S is saturated fatty acid and O is oleic acid. The milk chocolate-like products were produced using these fat materials and the recipes used are set out in Table 2.

TABLE 2
Recipes for milk chocolate-like products.

| Ingredients | Reference | Reference | Product | Product | Product | Product |
|---|---|---|---|---|---|---|
| (wt. %) | Product 1 | Product 2 | 1a | 1b | 1c | 1d |
| Cocoa mass | 18 | 18 | 18 | 18 | 18 | 18 |
| (containing | | | | | | |
| 52% cocoa | | | | | | |
| butter) | | | | | | |
| Skimmed milk | 16.4 | 16.4 | 16.4 | 16.4 | 16.4 | 16.4 |
| powder | | | | | | |
| Cocoa butter | 9 | 14 | 9 | 9 | 9 | 9 |
| Anhydrous | 4.6 | 4.6 | — | — | — | — |
| milk fat | | | | | | |
| Fat | — | — | 4.6 | 4.57 | 4.5986 | 4.5756 |
| composition 1 | | | | | | |
| Soft CBE | 5 | — | 5 | 5 | 5 | 5 |
| Sunflower | 0.5 | 0.5 | 0.5 | 0.5 | 0.5 | 0.5 |
| lecithin | | | | | | |
| Sugar | 46.5 | 46.5 | 46.5 | 46.5 | 46.5 | 46.5 |
| Milky butter | — | — | — | 0.03 | 0.0014 | 0.0014 |
| flavoring | | | | | | |
| (commercially | | | | | | |
| available from | | | | | | |
| MANE) | | | | | | |
| Oat milk | — | — | — | — | — | 0.023 |
| powder | | | | | | |
| (commercially | | | | | | |
| available from | | | | | | |
| Dohler) | | | | | | |
| Total fat | 27.96 | 27.96 | 27.96 | 27.93 | 27.96 | 27.94 |
| content | | | | | | |
| Total | 100 | 100 | 100 | 100 | 100 | 100 |

| Ingredients | | | | | |
|---|---|---|---|---|---|
| (wt. %) | Product 2 | Product 3 | Product 4 | Product 5 | Product 6 |
| Cocoa mass | 18 | 18 | 18 | 18 | 18 |
| (containing | | | | | |
| 52% cocoa | | | | | |
| butter) | | | | | |
| Skimmed milk | 16.4 | 16.4 | 16.4 | 16.4 | 16.4 |
| powder | | | | | |
| Cocoa butter | 9 | 9 | 9 | 14 | 9 |
| Fat | — | — | 4.6 | 4.6 | 4.6 |
| composition 1 | | | | | |
| Fat | 4.6 | — | — | — | — |
| composition 2 | | | | | |
| Fat | — | 4.6 | — | — | — |
| composition 3 | | | | | |
| Soft CBE | 5 | 5 | — | — | — |
| Hard CBE | — | — | — | — | 5 |
| Refined shea | — | — | 5 | — | — |
| butter | | | | | |
| Sunflower | 0.5 | 0.5 | 0.5 | 0.5 | 0.5 |
| lecithin | | | | | |
| Sugar | 46.5 | 46.5 | 46.5 | 46.5 | 46.5 |
| Total fat | 27.96 | 27.96 | 27.96 | 27.96 | 27.96 |
| content | | | | | |
| Total | 100 | 100 | 100 | 100 | 100 |

Cocoa mass contains 52% fat which is cocoa butter and skimmed milk powder is essentially free of fat. For each product, the required fat components were completely melted. Dry ingredients were mixed with some of the melted fat (~25% of total fat components) in a mixer until a dry paste was formed. The paste was refined using a refiner and the particle size was controlled at 19-20 μm. The refined paste was added into a conche together and subjected to conching at about 60° C. for 4 hours. The remaining melted fat and the lecithin were added half an hour before the end of the conching step and mixed. The chocolate mass was then formed and tempered. About 60 square tablets were produced and the tablets were stored at 18° C.

The fat phases of each milk chocolate product were analyzed and the analytical results of each fat phase are shown in Table 3.

TABLE 3
Analytical results of Reference fat phase 1, Reference fat phase 2, Fat
phases 1 to 6.

| | Product | | | |
|---|---|---|---|---|
| | | | Product | |
| | Ref. | Ref. | 1 (1a, | |
| | Product | Product | 1b, 1c | Product |
| | 1 | 2 | and 1d) | 2 |
| | Fat phase | | | |
| | Ref. fat | Ref. fat | Fat | Fat |
| | phase 1 | phase 2 | phase 1 | phase 2 |
| S26N10 | 71.0 | 75.7 | 71.1 | 72.5 |
| S26N20 | 47.2 | 57.6 | 46.8 | 46.5 |
| S26N25 | 36.1 | 46.8 | 35.5 | 37.6 |
| S26N30 | 14.7 | 23.8 | 14.5 | 20.8 |
| S26N35 | 0.0 | 0.3 | 0.0 | 0.4 |
| C8:0 | 0.7 | 0.6 | 0.7 | 0.1 |
| C10:0 | 0.6 | 0.5 | 0.6 | 0.1 |
| C12:0 | 4.6 | 4.3 | 4.7 | 1.4 |
| C14:0 | 2.0 | 1.8 | 2.1 | 0.8 |
| C16:0 | 26.2 | 23.4 | 26.2 | 31.1 |
| C16:1 | 0.2 | 0.2 | 0.2 | 0.2 |
| C17:0 | 0.2 | 0.2 | 0.2 | 0.2 |
| C18:0 | 27.1 | 32.0 | 27.1 | 26.3 |
| C18:1 | 32.6 | 31.9 | 33.2 | 34.0 |
| C18:2 | 4.1 | 3.3 | 3.6 | 4.4 |
| C18:3 | 0.4 | 0.4 | 0.2 | 0.2 |
| C20:0 | 0.9 | 0.9 | 0.9 | 0.9 |
| C20:1 | 0.1 | 0.1 | 0.1 | 0.1 |
| C22:0 | 0.2 | 0.2 | 0.2 | 0.2 |
| C24:0 | 0.1 | 0.1 | 0.1 | 0.1 |
| C12:0 + C14:0 | 6.6 | 6.1 | 6.8 | 2.2 |
| C16:0 + 18:0 | 53.3 | 55.4 | 53.3 | 57.4 |
| SAFA | 62.6 | 64.0 | 62.7 | 61.2 |
| MUFA | 32.9 | 32.2 | 33.4 | 34.2 |
| PUFA | 4.5 | 3.7 | 3.7 | 4.5 |
| IV FAME | 36.4 | 34.5 | 35.3 | 37.5 |
| TRANS | 0.1 | 0.1 | 0.1 | 0.1 |
| CN26 | 0.1 | 0.0 | 0.2 | 0.2 |
| CN28 | 0.2 | 0.2 | 0.1 | 0.2 |
| CN30 | 0.7 | 0.6 | 1.6 | 0.5 |
| CN32 | 0.8 | 0.8 | 0.0 | 0.3 |
| CN34 | 1.2 | 1.0 | 1.2 | 0.4 |
| CN36 | 1.9 | 1.8 | 2.0 | 0.7 |
| CN38 | 2.0 | 1.9 | 2.0 | 0.6 |
| CN40 | 1.7 | 1.5 | 1.7 | 0.7 |
| CN42 | 2.0 | 1.8 | 2.0 | 0.8 |
| CN44 | 1.4 | 1.3 | 1.4 | 1.1 |
| CN46 | 1.1 | 1.0 | 1.1 | 1.3 |
| CN48 | 1.9 | 1.4 | 1.8 | 2.3 |
| CN50 | 21.1 | 15.7 | 20.9 | 25.2 |
| CN52 | 34.2 | 38.4 | 34.1 | 38.0 |
| CN54 | 27.9 | 30.8 | 27.9 | 26.0 |
| CN56 | 1.7 | 1.8 | 1.6 | 1.7 |
| CN58 | 0.2 | 0.2 | 0.3 | 0.2 |
| CN32 + CN34 + CN36 + | 7.6 | 7.0 | 6.9 | 2.7 |
| CN38 + CN40 | | | | |
| C44 + C46 + C48 | 4.4 | 3.7 | 4.3 | 4.7 |
| Diglyceride | 2.7 | 2.0 | 2.7 | 3.4 |
| 1,2-diglyceride | 0.8 | 0.5 | 0.8 | 1.0 |
| 1,3-diglyceride | 1.9 | 1.5 | 1.9 | 2.4 |
| | Product | | | |
| | Product 3 | Product 4 | Product 5 | Product 6 |
| | Fat phase | | | |
| | Fat phase | Fat phase | Fat phase | Fat phase |
| | 3 | 4 | 5 | 6 |
| S26N10 | 71.8 | 67.7 | 76.1 | 76.7 |
| S26N20 | 44.3 | 46.1 | 57.4 | 55.4 |
| S26N25 | 32.4 | 36.5 | 46.5 | 44.4 |
| S26N30 | 13.6 | 20.3 | 24.4 | 24.1 |
| S26N35 | 0.0 | 0.5 | 0.4 | 0.0 |
| C8:0 | 0.6 | 0.7 | 0.6 | 0.7 |
| C10:0 | 0.5 | 0.5 | 0.5 | 0.6 |
| C12:0 | 3.9 | 4.5 | 4.4 | 4.6 |
| C14:0 | 1.7 | 1.9 | 1.8 | 1.9 |
| C16:0 | 25.6 | 19.5 | 23.6 | 24.4 |
| C16:1 | 0.2 | 0.2 | 0.2 | 0.2 |
| C17:0 | 0.2 | 0.2 | 0.2 | 0.2 |
| C18:0 | 28.8 | 32.9 | 31.9 | 30.8 |
| C18:1 | 33.4 | 34.3 | 32.5 | 32.3 |
| C18:2 | 3.6 | 3.5 | 2.8 | 2.9 |
| C18:3 | 0.2 | 0.2 | 0.2 | 0.1 |
| C20:0 | 0.9 | 1.1 | 0.9 | 1.0 |
| C20:1 | 0.1 | 0.1 | 0.1 | 0.1 |
| C22:0 | 0.2 | 0.2 | 0.2 | 0.2 |
| C24:0 | 0.1 | 0.1 | 0.1 | 0.1 |
| C12:0 + C14:0 | 5.6 | 6.4 | 6.2 | 6.5 |
| C16:0 + 18:0 | 54.4 | 52.4 | 55.5 | 55.2 |
| SAFA | 62.4 | 61.6 | 64.2 | 64.3 |
| MUFA | 33.7 | 34.6 | 32.7 | 32.6 |
| PUFA | 3.8 | 3.6 | 3.0 | 3.1 |
| IV FAME | 35.6 | 36.2 | 33.5 | 33.4 |
| TRANS | 0.1 | 0.1 | 0.0 | 0.1 |
| CN26 | 0.3 | 0.1 | 0.0 | 0.0 |
| CN28 | 0.3 | 0.1 | 0.2 | 0.2 |
| CN30 | 0.7 | 0.7 | 0.6 | 0.6 |
| CN32 | 0.8 | 0.8 | 0.8 | 0.8 |
| CN34 | 1.0 | 1.1 | 1.1 | 1.1 |
| CN36 | 1.5 | 1.7 | 1.8 | 1.8 |
| CN38 | 1.6 | 2.0 | 1.9 | 1.9 |
| CN40 | 1.3 | 1.7 | 1.5 | 1.6 |
| CN42 | 1.9 | 2.4 | 1.8 | 1.7 |
| CN44 | 1.5 | 1.5 | 1.3 | 1.3 |
| CN46 | 1.2 | 1.0 | 1.0 | 1.0 |
| CN48 | 3.3 | 1.4 | 1.7 | 1.3 |
| CN50 | 21.3 | 12.8 | 19.6 | 15.7 |
| CN52 | 34.0 | 32.4 | 32.5 | 38.4 |
| CN54 | 27.4 | 38.0 | 32.0 | 30.8 |
| CN56 | 1.7 | 2.0 | 1.7 | 1.7 |
| CN58 | 0.3 | 0.3 | 0.3 | 0.3 |
| CN32 + CN34 + CN36 + | 6.2 | 7.3 | 7.1 | 7.2 |
| CN38 + CN40 | | | | |
| C44 + C46 + C48 | 6.0 | 3.9 | 4.0 | 3.6 |
| Diglyceride | 2.7 | 3.0 | 2.0 | 2.0 |
| 1,2-diglyceride | 0.8 | 0.7 | 0.5 | 0.5 |
| 1,3-diglyceride | 1.9 | 2.2 | 1.5 | 1.5 |

A method based on thin-layer chromatography (TLC) and the partial hydrolysis of triglyceride with Grignard reagent was used to quantify the fatty acid esterified in SN-2 position of triglycerides in Reference fat phases 1-2 and Fat phases 1-6 further by GC-FAME (ISO 12966-2:2014 and ISO 12966-4:2015) based on the total weight of C8 to C24 fatty acids. The analytical results are shown in Table 4.

TABLE 4
Fatty acid composition on SN-2 position of Reference fat phase 1,
Reference fat phase 2, Fat phases 1 to 6.

| | Reference fat | Reference fat | Fat phase | Fat phase |
|---|---|---|---|---|
| Fat phase | phase 1 | phase 2 | 1 | 2 |
| C8:0 | 0.7 | 0.7 | 0.8 | 0.0 |
| C10:0 | 0.6 | 0.6 | 0.6 | 0.0 |
| C12:0 | 6.1 | 6.0 | 6.7 | 1.6 |
| C14:0 | 1.8 | 1.6 | 1.9 | 0.6 |
| C16:0 | 3.6 | 2.3 | 3.7 | 5.2 |
| C16:1 | 0.2 | 0.2 | 0.2 | 0.2 |
| C17:0 | 0.0 | 0.0 | 0.0 | 0.0 |
| C18:0 | 2.3 | 2.4 | 2.3 | 1.4 |
| C18:1 | 75.3 | 77.8 | 75.8 | 80.9 |
| C18:2 | 8.6 | 7.5 | 7.7 | 9.6 |
| C18:3 | 0.7 | 0.7 | 0.3 | 0.3 |
| C20:0 | 0.1 | 0.0 | 0.0 | 0.0 |
| C20:1 | 0.0 | 0.0 | 0.0 | 0.0 |
| C22:0 | 0.0 | 0.0 | 0.0 | 0.0 |
| C24:0 | 0.0 | 0.0 | 0.0 | 0.0 |
| C12:0 + C14:0 | 7.9 | 7.7 | 8.6 | 2.2 |
| C16:0 + C18:0 | 5.8 | 4.7 | 6.0 | 6.6 |
| Sn-2 total C12:0 | 39.7% | 42.0% | 42.0% | 34.0% |
| and C14:0% | | | | |
| Sn-2 total C16:0 | 3.6% | 2.8% | 3.8% | 3.8% |
| and C18:0% | | | | |
| Sn-2 C18:1% | 77.0% | 81.2% | 76.1% | 79.4% |
| Fat phase | Fat phase 3 | Fat phase 4 | Fat phase 5 | Fat phase 6 |
| C8:0 | 0.5 | 0.7 | 0.7 | 0.7 |
| C10:0 | 0.4 | 0.7 | 0.6 | 0.5 |
| C12:0 | 5.7 | 6.3 | 6.0 | 6.1 |
| C14:0 | 1.4 | 1.7 | 1.7 | 1.7 |
| C16:0 | 3.0 | 2.3 | 2.3 | 3.1 |
| C16:1 | 0.2 | 0.2 | 0.2 | 0.2 |
| C17:0 | 0.0 | 0.0 | 0.0 | 0.0 |
| C18:0 | 3.8 | 3.3 | 2.4 | 2.6 |
| C18:1 | 76.8 | 76.9 | 79.0 | 78.0 |
| C18:2 | 7.7 | 7.4 | 6.6 | 6.7 |
| C18:3 | 0.3 | 0.3 | 0.3 | 0.2 |
| C20:0 | 0.1 | 0.1 | 0.0 | 0.0 |
| C20:1 | 0.0 | 0.0 | 0.0 | 0.0 |
| C22:0 | 0.0 | 0.0 | 0.0 | 0.0 |
| C24:0 | 0.0 | 0.0 | 0.0 | 0.0 |
| C12:0 + C14:0 | 7.1 | 8.0 | 7.7 | 7.8 |
| C16:0 + C18:0 | 6.8 | 5.6 | 4.7 | 5.7 |
| Sn-2 total C12:0 | 42.2% | 41.8% | 41.3% | 40.1% |
| and C14:0% | | | | |
| Sn-2 total C16:0 | 4.2% | 3.6% | 2.8% | 3.5% |
| and C18:0% | | | | |
| Sn-2 C18:1% | 76.7% | 74.8% | 81.0% | 80.5% |

Fat phases 1, 4, 5 and 6 contained 16.5% by weight of Fat composition 1. Fat phase 2 contained 16.5% by weight of Fat composition 2. Fat phase 3 contained 16.5% by weight of Fat composition 3.

### Example 3—Evaluation of the Milk Chocolate Products

Products 1a, 1b, 1c and 1b were evaluated in terms of organoleptic properties where Reference Product 1 was used as a reference as a common milk chocolate product for comparison. 15 panelists participated in the sensory evaluation where the test environment was in a room at around 20° C. The samples were presented with a series of coded test sample and one sample was the blind reference which was presented as another product sample. The panelists were asked to assess multiple pairs where each time the reference sample and then the coded test sample/blind reference were assessed. The order of sample presentation was balanced across the panel and session.

The panelists were asked to test the control sample first, then cleanse the mouth with lukewarm water, and then test the coded test sample. They were asked to indicate the magnitude of the difference between the two samples using a 5-point category scale for the attributes: Hardness, Melting rate, Thickness of the melt, Coolness, Sweetness, Flavor Intensity Milky and Flavor Intensity Cocoa.

These attributes are described in Table 5 as below.

TABLE 5
Attributes of milk chocolate product.

| Attribute | Definition | Tasting instructions | Scores | |
|---|---|---|---|---|
| Hardness | The force | Bite through middle | Much softer: | −2 |
| | necessary to | of sample using | Softer: | −1 |
| | completely | front teeth | Equal: | 0 |
| | bite through | | Harder: | +1 |
| | the sample | . | Much harder: | +2 |
| | when taking | | | |
| | it between | | | |
| | the teeth | | | |
| Melting | The total time | Place the sample on | Much slower: | −2 |
| rate | the sample | the tongue - start | Slower: | −1 |
| | takes to | timer - suck on the | Equal: | 0 |
| | completely | sample until | Faster: | +1 |
| | melt in the | everything is gone | Much faster: | +2 |
| | mouth | while measuring the | | |
| | | time. | | |
| Thickness | Consistency | Place sample on the | Much lower: | −2 |
| of the | of melted | tongue and suck on it. | Lower: | −1 |
| melt | chocolate | Experience whether | Equal: | 0 |
| | | the melted sample | Higher: | +1 |
| | | feels thick or thin in | Much higher: | +2 |
| | | the mouth. Assess | | |
| | | once chocolate is | | |
| | | melted prior to | | |
| | | swallowing. | | |
| Coolness | Cooling | Place the sample on | Much lower: | −2 |
| | sensation in | the tongue and suck | Lower: | −1 |
| | the mouth | on it. Experience | Equal: | 0 |
| | often | whether there is a | Higher: | +1 |
| | experienced | cooling sensation. | Much higher: | +2 |
| | with mint and | | | |
| | menthol. | | | |
| Sweetness | Taste quality | Place the sample on | Much lower: | −2 |
| | associated | the tongue and suck | Lower: | −1 |
| | with sugar | on it. Experience the | Equal: | 0 |
| | | sweetness intensity | Higher: | +1 |
| | | which is released. | Much higher: | +2 |
| Flavor | The flavor of | Place the sample on | Much lower: | −2 |
| Intensity | sweetened | the tongue and suck | Lower: | −1 |
| Milky | condensed | on it. Experience the | Equal: | 0 |
| | milk and/or | milky/dairy flavor | Higher: | +1 |
| | evaporated | intensity which is | Much higher: | +2 |
| | milk. | released. | | |
| Flavor | The flavor of | Place the sample on | Much lower: | −2 |
| Intensity | cocoa | the tongue and suck | Lower: | −1 |
| Cocoa | | on it. Experience the | Equal: | 0 |
| | | cocoa flavor intensity | Higher: | +1 |
| | | which is released. | Much higher: | +2 |

The mean panel data are shown in Table 6 below. The mean for Reference Product 1 (blind control) is a measure of the placebo effect, as it is the result when no change was applied and the sample was in fact a duplicate control.

TABLE 6
Mean panel sensory data

| | Reference | Product | Product | Product | Product |
|---|---|---|---|---|---|
| Attribute | Product 1 | 1a | 1b | 1c | 1d |
| Hardness | 0.0 | 0.0 | 0.0 | +0.3 | +0.1 |
| Melting | +0.2 | −0.1 | 0.0 | +0.1 | −0.2 |
| rate | | | | | |
| Thickness | −0.1 | −0.3 | −0.1 | −0.3 | 0.0 |
| of the melt | | | | | |
| Coolness | +0.2 | 0.0 | +0.3 | +0.3 | −0.1 |
| Sweetness | +0.2 | +0.3 | +0.1 | − 0.1 | +0.4 |
| Flavor | −0.3 | +0.2 | +0.4 | −0.5 | −0.2 |
| Intensity | | | | | |
| Milky | | | | | |
| Flavor | −0.1 | −0.1 | −0.5 | +0.3 | −0.1 |
| Intensity | | | | | |
| Cocoa | | | | | |

It could be observed that all products 1a, 1b, 1c and 1d having a plant-based fat phase have very similar organoleptic properties as reference product 1 while the products 1a, 1b, 1c and 1d does not contain any milk fat. In addition, these confectionery products according to the invention also achieved similar desirable flavour sensory properties without using high amounts of flavour additives. Furthermore, the confectionery product according to the invention further comprising oat milk powder showed promising sensory properties which were very close to the common milk chocolate without being negatively impacted by the addition of plant milk power. This suggests the further possibility to completely replace milk powder by plant milk power in the similar confectionery product.

1. A confectionery product comprising from 20% to 70% by weight of a sweetener; and from 20% to 70% by weight of a plant-based fat phase;
wherein the plant-based fat phase has:
from 1.0% to 10.0% by weight of total lauric acid (C12:0) and myristic acid (C14:0); and
from 20.0% to 70.0% by weight of total palmitic acid (C16:0) and stearic acid (C18:0);
said percentages of acid referring to acids bound as acyl groups in glycerides of the plant-based fat phase and being based on the total weight of C8 to C24 fatty acids;
a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of at least 1.0%;
at most 10.0% by weight of total CN32 triglycerides, CN34 triglycerides, CN36 triglycerides, CN38 triglycerides and CN40 triglycerides;
based on total triglycerides present in the plant-based fat phase.

2. The confectionery product according to claim 1, comprising:
from 30% to 65% by weight of the sweetener;
and/or
from 20% to 60% by weight of the plant-based fat phase; and/or
wherein the product further comprises at most 10% by weight of water.

3. The confectionery product according to claim 1, further comprising one or more ingredients selected from cocoa powder, cocoa mass, skimmed milk powder, vanillin, emulsifier, colorant and flavoring.

4. The confectionery product according to claim 3, wherein the confectionery product further comprises at most 0.10% by weight of butter flavoring.

5. The confectionery product according to claim 1 further comprising a plant-based milk powder selected from the group of almond milk powder, soy milk powder, coconut milk powder, rice milk powder, oat milk powder, hemp milk powder, pea milk powder, peanut milk powder, cashew milk powder, triticale milk powder, wheat milk powder, barley milk powder, spelt milk powder, millet milk powder, and mixtures thereof.

6. The confectionery product according to claim 5, wherein the confectionery product further comprises from 0.001% to 0.5% by weight of plant-based milk powder.

7. The confectionery product according to claim 1, wherein the confectionery product is a chocolate, a chocolate-like product, a coating, a filling, an icing or a spread.

8. The confectionery product according to claim 1, wherein the plant-based fat phase in the confectionery product has:
from 0.5% to 10% by weight of lauric acid (C12:0); and/or
at most 8.0% by weight of myristic acid (C14:0); and/or
from 1.5% to 9.0% by weight of total lauric acid (C12:0) and myristic acid (C14:0); and/or
from 10.0% to 50.0% by weight of palmitic acid (C16:0); and/or
from 15.0% to 55.0% by weight of stearic acid (C18:0); and/or
from 25.0% to 68.0% by weight of total palmitic acid (C16:0) and stearic acid (C18:0); and/or
from 20.0% to 50.0% by weight of oleic acid (C18:1); and/or
at most 10.0% by weight of linoleic acid (C18:2);
said percentages of acid referring to acids bound as acyl groups in glycerides of the plant-based fat phase and being based on the total weight of C8 to C24 fatty acids.

9. The confectionery product according to claim 1, wherein the plant-based fat phase in the confectionery product has: a percentage of total lauric acid (C12:0) and myristic acid (C14:0) on the second position of triglycerides out of total lauric acid (C12:0) and myristic acid (C14:0) (Sn-2 total lauric acid and myristic acid %) in the triglycerides of the plant-based fat phase of from 20.0% to 60.0% and/or
a percentage of total palmitic acid (C16:0) and stearic acid (C18:0) on the second position of triglycerides out of total palmitic acid (C16:0) and stearic acid (C18:0) (Sn-2 total palmitic acid and stearic acid %) in the triglycerides of the plant-based fat phase of from 1.0% to 10.0% and/or
a percentage of oleic acid (C18:1) on the second position of triglycerides out of total oleic acid (C18:1) (Sn-2 oleic acid %) in the triglycerides of the plant-based fat phase of from 55.0% to 90.0%.

10. The confectionery product according to claim 1, wherein the plant-based fat phase in the confectionery product has:
from 0.5% to 9.5% by weight of total CN32 triglycerides, CN34 triglycerides, CN36 triglycerides, CN38 triglycerides and CN40 triglycerides; and/or
at least 3.0% by weight of total CN44 triglycerides, CN46 triglycerides and CN48 triglycerides; and/or
from 5.0% to 38.0% by weight of CN50 triglycerides; and/or
from 25.0% to 50.0% by weight of CN52 triglycerides; and/or
from 20.0% to 50.0% by weight of CN54 triglycerides
based on total triglycerides present in the plant-based fat phase.

11. The confectionery product according to claim 1, wherein the plant-based fat phase in the confectionery product has:
from 45.0 to 90.0 solid fat content at 10° C.; and/or
from 30.0 to 75.0 solid fat content at 20° C.; and/or
from 20.0 to 65.0 solid fat content at 25° C.; and/or
from 5.0 to 40.0 solid fat content at 30° C.;
measured on fat stabilized at 26° C. for 40 hours according to ISO 8292-1:2008.

12. The confectionery product according to claim 1, wherein the plant-based fat phase in the confectionery product has:
from 0.5% to 5.0% by weight of diglycerides; and/or
at most 2.0% by weight of 1,2-diglycerides; and/or
at most 3.0% by weight of 1,3-diglycerides.

13. The confectionery product according to claim 1, wherein the plant-based fat phase in the confectionery product comprises:
from 3% to 20% by weight of an interesterified fat blend comprising at least a lauric fat; and wherein the lauric fat in the interesterified fat blend is present in an amount of from 30% to 80% by weight;
optionally wherein the plant-based fat phase in the confectionery product further comprises from 3% to 15% by weight of a liquid oil.

14. The confectionery product according to claim 1, wherein the plant-based fat phase in the confectionery product consists of:
from 5% to 18% by weight of an interesterified fat blend; wherein the interesterified fat blend consists of from 35% to 75% by weight of a lauric fat selected from the group consisting of coconut oil, palm kernel oil, a fraction thereof and a mixture thereof and 25% to 65% by weight of a fat selected from the group consisting of cocoa butter, shea butter, palm oil, illipe butter, mango oil, sal butter, kokum oil, a fraction thereof and a mixture thereof, based on the total weight of the interesterified fat blend;
from 5% to 10% by weight of liquid oil selected from the group consisting of sunflower oil, high oleic sunflower oil, high stearic high oleic sunflower oil, high oleic rapeseed oil, high oleic canola oil, high oleic soybean oil, rapeseed oil, rice oil, soybean oil, chia oil, flaxseed oil, corn oil, safflower oil, olive oil, canola oil, grapeseed oil, pumpkin oil, sesame oil, walnut oil, hazelnut oil, coconut oil, palm olein, a fraction thereof and a mixture thereof; and
from 72% to 90% by weight of a fat containing at least 40% by weight of SOS triglycerides based on the total glycerides present in the fat, wherein S is saturated acid and O is oleic acid.

15. A process for preparing the confectionery product according to claim 1, comprising the steps of:
providing an interesterified fat blend comprising at least a lauric fat;
providing a liquid oil;
mixing the interesterified fat blend, the liquid oil, a sweetener, optionally water, optionally one or more ingredients selected from cocoa powder, cocoa mass, skimmed milk powder, vanillin, emulsifier, colorant and flavoring and optionally a plant milk powder; and
processing the mixture to form the confectionery product.
